(19) United States
(12) Patent Application Publication
(10) Pub. No.: US 2008/0005510 A1
(43) Pub. Date: Jan. 3, 2008

(54) Compression Method for Managing the Storing of Persistent Data From a Non-Volatile Memory to a Backup Buffer

(75) Inventors: Paolo Sepe, Quarto (IT); Luca Di Cosmo, S. Angelo D'Alife (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: INCARD S.A., Geneva (CH)

(21) Appl. No.: 11/770,854

(22) Filed: Jun. 29, 2007

(30) Foreign Application Priority Data
Jun. 29, 2006 (EP) 06013461.6

(51) Int. Cl. G06F 12/16

(52) U.S. Cl. 711/162; 711/103

(57) ABSTRACT

A compression method for a backup data buffer includes a plurality of backup entries for storing persistent data of a non-volatile memory device during at least one update operation. An address of the persistent data in the non-volatile memory device is stored in a driver buffer including address pages. Each address page includes address entries. The compression method includes the functions for marking as erasable an address entry included in a first address page of the driver buffer when the at least one update operation on the persistent data is completed. Address entries not marked as erasable or non-erasable are copied from the first address page to a second address page of the driver buffer. The second address page contains address entries not marked as erasable. The first address page is erased for rendering it ready to be written. The content of the second address page is written to the first, and the second address page is for future writings.

### FIELD OF THE INVENTION

The present invention relates to a compression method for managing the storing of persistent data from a volatile memory device to a Backup buffer comprising a plurality of Backup entries before the execution of at least one update operation that involves the persistent data. More particularly, if an unexpected event occurs, the value of the persistent data involved in the at least one update operation is to be restored in a consistent state from the Backup buffer.

### BACKGROUND OF THE INVENTION

A non-volatile memory, such as a Flash memory or an EEPROM memory, is used in an electronic device to store non-volatile data. Such non-volatile data is also indicated as persistent data because their content may be variable during the programming phases of the electronic memory device, but their values need to be preserved during power off.

More particularly, the non-volatile memory assures that the value of persistent data is not lost after a regular switch-off of the electronic device. That is, when the electrical deactivation occurs in an idle state of the device. This is the typical case wherein the deactivation is driven by an operating system of a terminal that the device is connected to, or directly belonging to the electronic device.

If an accidental electrical deactivation occurs during an application execution, specifically during an updating operation of persistent data, it is possible that the value of persistent data is left in an inconsistent state that could compromise, completely or partially, the functioning of the electronic device in the successive power-on sessions.

A prior art document, European patent no. 964,360, relates to a method for supplying power to an integrated circuit card comprising a microprocessor, a volatile memory (RAM) and a non-volatile memory (ROM, EEPROM) in case of an unexpected power off. This approach tries to overcome the above problem by always keeping the power supply to the memory device.

A second prior art document, U.S. published patent application no. 2005/0055498, relates to an integrated circuit card comprising failure protection for maintaining power in case of a power supply failure, and a power failure detector for sensing a corresponding power supply failure.

These prior art documents disclose methods based on providing additional power to the electronic device for concluding sensing operations before the unexpected switch off of the device. However, they do not consider a transaction method for storing persistent data also in case of other unexpected events, such as those events not determined by a power off, for example.

The value of persistent data may be preserved according to other methods that substantially copy it in a Backup buffer during the execution of an arbitrary number of writing operations. More particularly, the arbitrary number of writing operations is considered a single atomic writing operation with respect to unexpected events comprising a power off.

The arbitrary number of writing operations grouped may be considered a “Secure Update” because the value of the persistent data they process are to be restored in a consistent state from the Backup buffer after an unexpected event. Generally, these methods mark a plurality of writing operations involved in a “Secure Update” between first and second pseudo-instructions, respectively BeginTransaction and CommitTransaction, as schematically shown in FIG. 1.

In case of unexpected events during the execution of an operation included between the Begin Transaction and the Commit Transaction, the values of the persistent data are restored in the non-volatile memory at the next device start-up to the value they had before the Begin Transaction instruction.

More particularly, the method is based on a Backup buffer, that is, a portion of non-volatile memory wherein the values of persistent data are stored before the starting of a Begin Transaction instruction. If an unexpected event occurs, the initial-consistent values of persistent data are retrieved from the Backup buffer and are restored in the non-volatile memory.

The non-volatile memory allows a limited number of writing accesses. Over this limit, the “data retention time” of the non-volatile memory decreases to values not acceptable for any applicable purpose. For example, the number of the allowed writing operations for EEPROM or Flash memories is typically in the range of 100,000 to 1,000,000.

This limitation has impact on the implementation of the method for driving the Backup buffer, as any “Secure Update” involving a number of secure writing operations has the side effect of a further writing in the Backup buffer. Moreover, depending on how the method drives the storing of persistent data inside the Backup buffer, different write operations may stress some bytes of the Backup buffer more than others. In other words, different portion or bytes of the Backup buffer could be used not uniformly.

The maximum number of writing operations on such particularly stressed bytes bounds the number of the “Secure updating” operations allowed to the applications in the non-volatile memory. Even if the device is guaranteed for 100,000 writing operations on each single byte of the non-volatile memory, the electronic device cannot perform more than 100,000 “Secure updating”, even on different memory bytes, because in opposite cases the bytes already stressed in the Backup buffer could be damaged.

Moreover, a state of the art non-volatile memory, such as Flash memory devices and several EEPROM memories, are based on a plurality of memory regions. Each memory region comprising a number of bits defining its granularity.

More particularly, it is not possible to erase single bits within a memory region. The erasing of single or several bits within a memory region requires erasing the whole region they belong to for granularity issues in the memory region. The same problem affects the updating operation because in such memories a writing operation requires first an erase operation to set the memory region in a “ready to be written” state.

When an unexpected event such as an accidental electrical power off occurs, because of the granularity issue, not only the bits involved in the actual write operation but all the bytes that belong to the memory regions involved in the update operation, are affected by this problem.

More particularly, this problem should be faced not only during a “Secure Update” but also during a non-secure update, hereinafter indicated as a “Non-atomic update.” In other words, when it is not required that all the operations involved in such an update are considered as a single atomic operation.

With reference to FIG. 2a, a non-volatile memory 1 is schematically shown comprising a plurality of memory portions R1, R2, R3, R4. During a “Secure Update” instruction, memory portions R1, R2, R3 and R4 are involved in a writing operation. Such writing operations affect, for example, persistent data stored in memory sub-regions R1b of the portion R1 and R4a of the portion R4.

The location containing persistent data to be updated is pointed by a “Start address” pointer and has a size equal to “Length”. The method that drives the Backup buffer needs to preserve the entire memory portions R1, R2, R3 and R4, storing all its content in a Backup buffer. This is so even if the writing operation does not affect the whole regions R1 and R4 but only the sub-regions R1b, R4a. Memory regions R1 and R4 need to be preserved completely because the writing operation requires an erase operation on them, due to granularity issues.

FIG. 2b schematically shows the same non-volatile memory 1 wherein a “Non-atomic Update” is performed. Also in this case memory portions R1, R2, R3 and R4 are involved in a non-atomic writing operation that affects persistent data stored in a location represented by memory sub-region R1b, memory regions R2 and R3, and memory sub-region R4a.

Also in this case the method that drives the Backup buffer preserves memory portions R1 and R4 because sub-regions R1a and R4b, even if not directly involved in the writing operation, need to be preserved. Vice versa, regions R2 and R3 are not preserved. In fact, while the value involved in the “Non-atomic update” and stored in the non-volatile memory could be deliberately left in a partially modified state because of not belonging to a “Secure Update”, it is not acceptable that the same happens for adjacent bits that are involved in the memory portions erasing only for granularity issue.

Both “Secure Update” and “Non-atomic update” operations would require a method for preserving persistent data against possible unexpected events occurred during update operations, determining an intensive use of the Backup buffer. For these reasons, the intensive use of the Backup buffer may determine the failure of an update operation due to an out of memory reason, because the Backup buffer space is not sufficient to store all the memory regions.

Since the Backup buffer stores a portion of non-volatile memory with a limited size and is driven by a method that stores in it persistent data during both “Secure Update” and “Non-atomic update”, the execution of a plurality of secure update operations may overflow its size. This is especially so because the Backup buffer needs to preserve a plurality of memory portions for their potential restoring in a non-volatile memory This is done not only during atomic updates but also during non-atomic updates that involve, for granularity issues, the erasing of persistent data that cannot be left in a non-consistent state. Moreover, a large amount of erase/write operations inside the Backup buffer, intended to release its Backup entries for avoiding overflow, may limit the life-time of the Backup buffer.

### SUMMARY OF THE INVENTION

In view of the foregoing background, an object of the present invention is to provide a compression method that releases as soon as possible Backup entries of a Backup buffer that are no longer involved in an update operation. Persistent data stored in the Backup entries of a first address page is copied into Backup entries of a second address page, and the first address page is erased so as to use it for storing persistent data associated with another update operation.

The compression method for a Backup Data buffer comprises a plurality of Backup entries for storing persistent data of a non-volatile memory device during at least one update operation involving such persistent data, and an address of the persistent data subject to updating being stored in one or more address entries of a first address page included in a driver buffer comprising a plurality of address pages.

The compression method may comprise marking as erasable an address entry included in the first address page when the update operation on the persistent data stored in such an address entry is completed. The method may further comprise copying from the first address page to a second address page of the driver buffer, the address entries not marked as erasable in the above marking step in order to compact or compress the not marked address entries in the second address page. The first address page may be erased to render the first address page ready to store persistent data involved in another update operation.

Advantageously, one or more address entries not marked as erasable may be copied from a first address page to a second address so that the first address page is erased and may be used for storing additional persistent data. This may avoid an overflow of the Backup buffer even when the Backup buffer size is limited. Advantageously, when a large number of address pages are involved in the storing of persistent data, the compression method may compress them inside a subset of the address pages, and release as many address pages as possible and avoiding a fragmented storage of persistent data.

Advantageously, the method may avoid an overflow of the Backup buffer when a plurality of such Backup buffer entries are used to preserve a plurality of memory portions during the execution of the update operations. The compression method may prevent storing of the Backup entries in a plurality of address pages when such storage may involve a lower number address pages.

### BRIEF DESCRIPTION OF THE DRAWINGS

The features and advantages of the invention will be apparent from the following description of an embodiment thereof, given by way of non-limiting examples with reference to the accompanying drawings.

FIG. 1 schematically shows a couple of [BeginTransaction and CommitTransaction] instructions grouping a set of update operations according to the prior art.

FIG. 2a schematically shows a set of adjacent memory portions of a non-volatile memory device that are involved in a “Secure Update” procedure according to the prior art.

FIG. 2b schematically shows a set of adjacent memory portions that are involved in a “Non-atomic update” procedure according to the prior art.

FIG. 3 schematically shows a Backup buffer and a driver buffer according to the present invention; and

FIGS. 4a to 4i schematically show the content of Index, Address and Length buffers during the execution of [BeginTransaction and CommitTransaction] instructions according to the present invention.

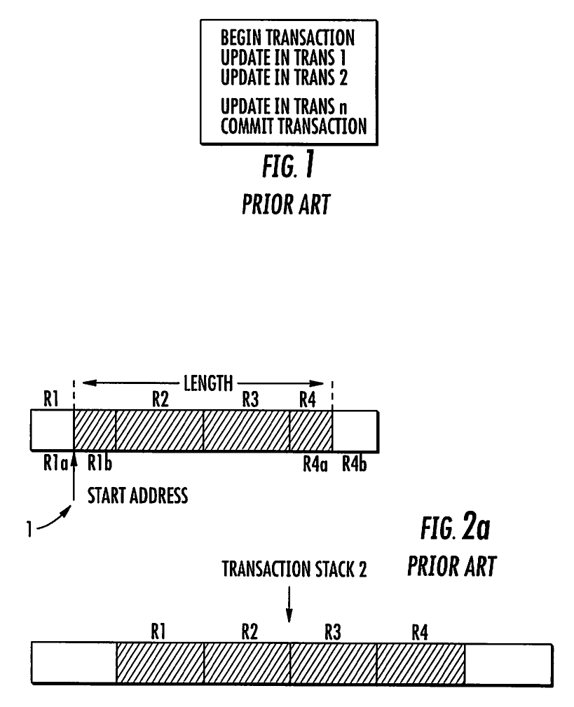

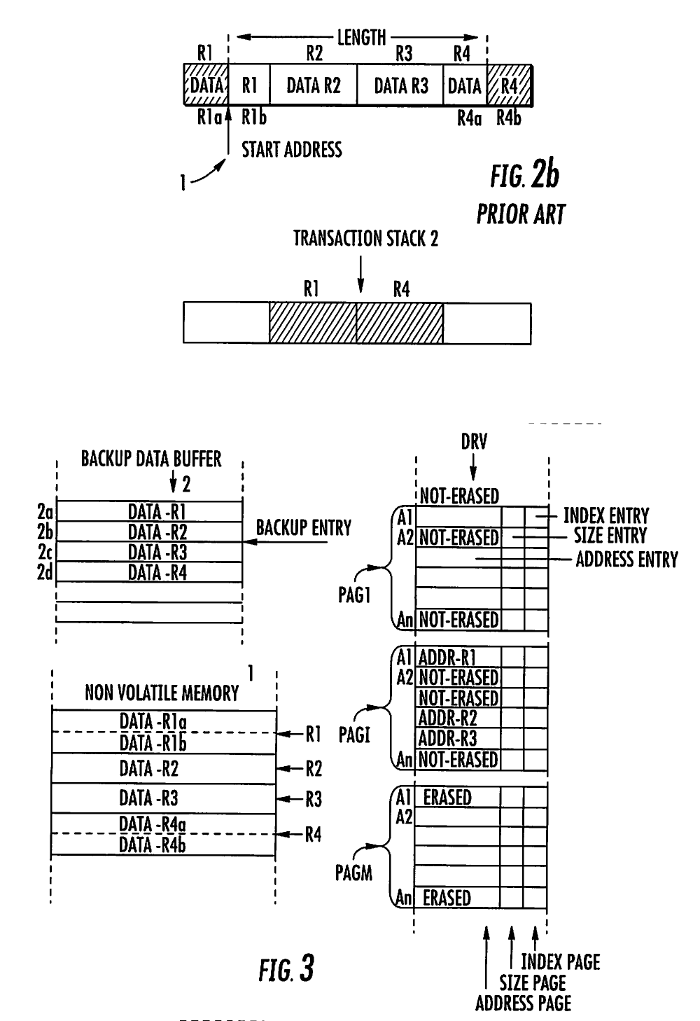

### DETAILED DESCRIPTION OF THE PREFERRED EMBODIMENTS

With more specific reference to FIG. 3, a non-volatile memory device 1 comprises a plurality of memory portions R1-R4 that are provided for respectively storing persistent data data-R1 . . . data-R4. In the same figure a Backup buffer 2 is also represented, and comprises a plurality of Backup entries 2a-2d for storing the persistent data data-R1 . . . data-R4 during update operations op1, op2.

More particularly, during the execution of such update operations op1, op2, a compression method drives the storing of persistent data data-R2, data-R3 contained in memory portions R2, R3 inside the Backup entries 2a, 2b of the Backup buffer 2. More particularly, an address Addr-R2, Addr-R3 wherein the memory portions R2, R3 are stored in a non-volatile memory 1 is recorded in an address entry A1, A2 included in an address page pag1 of a driver buffer drv.

The driver buffer drv comprises a plurality of address pages pag1, pag2, pagm. Each one sized equal or as a multiple of the non-volatile memory granularity, and each one includes a plurality of address entries A1, An. The compression method provides that the address entries inside the address buffer are written in a circular way, starting from the first address entry A1 of the first address page pag1 to the last address page An of the last address page pagn.

When the last address entry An of the last address page pagm is reached, the compression method driving the backup buffer and the driver buffer erase the contents of the first address page pag1 (entries A1-An) if all of its entries are erasable and restart cyclically to write the address buffer.

The compression method provides a set of functions for performing non-atomic updates without failures, even if they are required when the end of the backup buffer is reached, and the content of the first address entry A1 of the first address page pag1 is not ready to be written. In other words, the compression method is designed for avoiding overflow when non-atomic update operations are required while a secure update operation is in progress.

A first function provides to mark as erasable an address entry, for example the address entry A2, included in an address page pag1 of the driver buffer drv when the whole update operation op1, op2 is completed. More particularly, an address entry A2 is referred to a memory portion R2 wherein an update operation has already been completed, and so it has been marked as non-erasable. On the contrary, the address entry A1 is referred to a memory portion R1 wherein an update operation has not been already completed. So while the address entry A2 could be discarded to release space inside the address buffer and inside the Backup buffer for following update operations, the address entry A1 is not flagged as erasable because it still refers to a memory portion to be updated.

A second function provides the copying from a first address page pag1 to a second address page pag2 of the driver buffer drv of a plurality of address entries not marked as erasable or non-erasable to the second address page. Thus, since the second address page was only made of ready to be written pages, after copying it will contain only address entries not marked as erasable and entries that are ready to be written. More particularly, the second address page is used to store all the address entries that still refer to memory portions to be updated but that are stored inside an address page pag1 also containing address entries to be erased.

A third function allows erasing of the first address page, rendering it ready to be written. The content of the second address page is written into the first, and the second address page is to be erased.

The next goal is to compress the required entries and to release all the entries from an address page that are not required in order to use them for future update operations. The compression method advantageously drives the erasing operation of a plurality of address entries ready to be erased, and more particularly, all the address entries stored in an address page are erased.

More particularly, the compression method further comprises a function for copying the second address page pag2 of the driver buffer drv into the first address page pag1. The compression method also provides a push instruction for reading the persistent data data-R1, data-R2, data-R3, data-R4 from the non-volatile memory 1 device and storing them in one or more Backup entries of the Backup buffer 2, for example, in Backup entries 2a, 2b, 2c, and 2d. A pop instruction is provided for reading the persistent data data-R1, data-R2, data-R3, data-R4 from the Backup entries 2a, 2b, 2c, and 2d and restoring them in the corresponding memory portions R1, R2, R3, R4 of the non-volatile memory 1. A begin transaction marker indicates that one or more update operations are starting, and that such update operations should be considered as a single atomic update. A commit transaction marker marks that one or more of the update operations have finished.

More particularly, the driver buffer drv comprises all the information needed to recover persistent data inside the non-volatile memory 1 in a consistent state. This includes not only the value of the persistent data inside the non-volatile memory 1 device and its address, but also its size.

When a “Secure update”, for example involving memory portions R1b, R2, R3, R4a is requested, the compression method calls a push instruction for storing inside the Backup buffer 2 the information related to the memory regions R1, R2, R3, R4, since all of these memory regions are involved in the update operation.

Also, when a “Non-atomic update” is requested, the compression method calls a push instruction for storing inside the Backup buffer 2 only the memory regions R1, R4 of the memory regions R1, R2, R3, R4. When an update operation requires the storing of persistent data inside the backup Buffer, the compression method initializes a begin transaction marker for establishing that, in case of unexpected events, all the persistent data involved in such update operations need to be restored to the value they had before the initialization of the begin transaction marker.

More precisely, the compression method first checks if the Backup buffer 2 is currently marked by a begin transaction marker, for example, opened by a secure update previously called. In this case, the compression method pushes the memory portions R1 and R4 inside the Backup buffer 2. It performs the “Non-atomic update” and finally discards the related records from the Backup buffer 2 since the “update non-atomic” has been completed. Vice versa, if a Backup buffer 2 is not currently marked by a begin transaction marker, the compression method adds a backup entry on the Backup buffer 2 and then it proceeds as previously described.

After the execution of the update operation, the compression method closes the currently opened transaction since it has been opened only to manage the “Non-atomic update”. Advantageously, the driver buffer drv comprises structured information about the persistent data to be stored in the Backup buffer, in particular their Address, Length and Index inside the Backup buffer.

The driver buffer drv may advantageously comprise a plurality of buffers, for example, a buffer dedicated to store the Address that persistent data have in a non-volatile memory device, another buffer dedicated to store their size and a third buffer to store their index or address inside the Backup buffer.

The compression method provides a circular use of the three buffers so as to maximize the lifetime of the corresponding non-volatile memory, as well as a circular use of the Backup buffer. The length of the backup entries inside the Backup buffer is equal or is a multiple of the granularity of the non-volatile memory 1. This is so that the updating of a single backup entry does not require the erasing of adjacent backup entries. More particularly, the Backup buffer contains the original value of the persistent memory to be restored in case of an abort during an update operation. The portion of the entry that needs to be restored is identified by an Address-Length.

An index buffer comprises a plurality of index entries and links Address-Length entries inside Address-Length buffers to Backup entries inside Backup buffer. More particularly, the Index buffer provides that the same Backup entry can be related to more update operations, that insuring the reuse of the backup buffer. A Backup entry is advantageously conserved as long as possible, because it may be reused inside a same transaction without additional re-writing that limits the life time of the non-volatile memory 1.

To extend the lifetime of the non-volatile memory 1, it is important to insure the circularity in all four buffers. Since Index, Address and Length buffers are substantially aligned, their circularity is insured by markers in the Index buffer. These markers allow tracking of the last used entry in the Index buffer, and consequently, the last used entry in the Address and Length buffers.

Circularity of the Backup buffer, instead, is provided by saving in the Index buffer of the last used position of the Backup buffer. Moreover, before closing a transaction the last position used is saved too.

Unlike the update of Backup entries, update of Index, Address, Length entries needs to take into account the memory granularity since the length of a single entry cannot be a multiple of granularity in order not to waste memory space.

The size of the Index, Address, and Length pages are always equal or multiples of memory granularity, so that Index, Address and Length buffers are composed by an integer number of granularity pages. Each page can be completely erased without touching the rest of the buffer.

More particularly, when an index value needs to be written in an index entry within an Index page, two cases can be distinguished: the index entry is available for the writing, for example because it has been already erased; and the index entry is not available for the writing, for example because the index entry is not erased.

In the first case, no erase operation is needed but only a simple write operation is to be performed to store the new index value. In the second case, if possible, the whole Index page and the corresponding Address and Length pages are to be erased to make them available for writing.

If non-persistent memory granularity is 4-bytes, erased element is 0x00 and consequently not erased element is 0xFF, then the compression method may provide:
a) a Backup Entry size of 64 bytes, an Index, Length entry size of 1 byte and an Address entry size of 4 bytes;
b) an Index Page size of 4 bytes, the minimum value for allowing a safe page erasing;
c) a Length Page size of 4 bytes long to provide the correspondence with Index Pages; and
d) an Address Page size of 4*4 bytes to provide the correspondence with Index Pages.

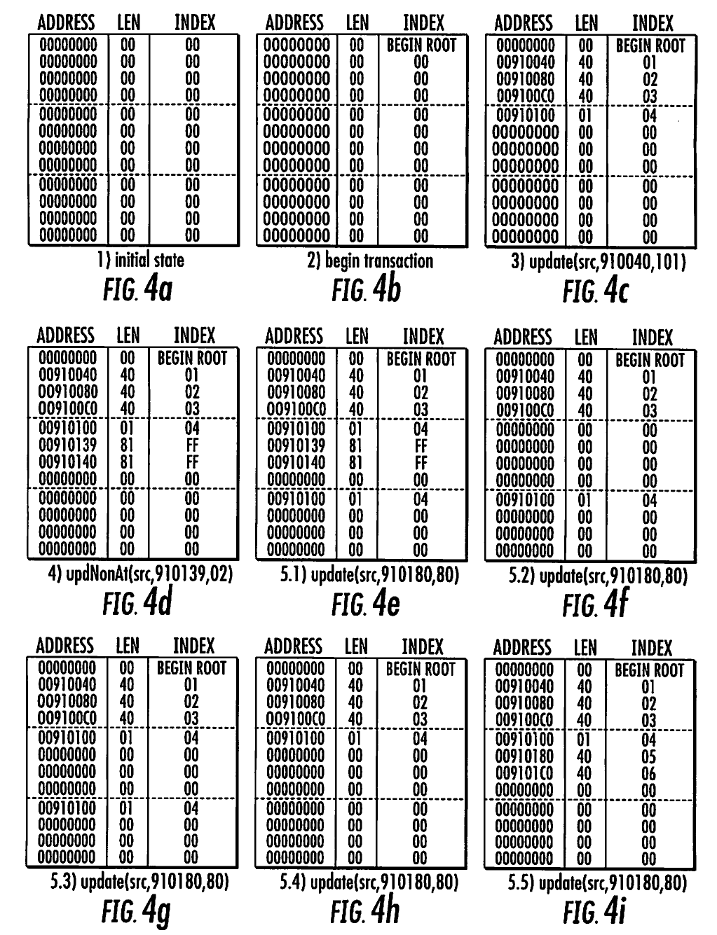

The core of the compression method takes place in an Index Buffer, which is represented with Address and Length buffers in FIGS. 4a-4i as an example of execution of an update operation.

More particularly, the following features of the compression method should be noted. In FIG. 4e an update operation cannot utilize the two address entries discarded in the address buffer since they are set to the “not erased state”. The next page is driven by the compression method as a backup address page for doing the compression.

In FIG. 4f, since a backup of valid address entries has happened inside the backup address page of the address buffer, the Index, Address and Length entries used for the corresponding update operation can be erased. In FIG. 4g, the valid address entries saved in the backup address page are written in the address page just erased. In FIG. 4h, the backup address page is erased, releasing all its entries for following writing operations. In FIG. 4i, the real update operation occurs.

The compression method advantageously allows the backup buffer to be driven for the storing of persistent data involved in update non-atomic operations, and when a transaction due to a nested update operation and filing some entries of the Backup buffer is closed, it releases resources to previous transactions.

Moreover, the compression method is circular since next address pages to a current address page are used as backup address pages. The compression method may advantageously be invoked only when a push operation requires a new address page before changing the address page. A check on the current address page may be done to verify if discarded address entries are present.

1-9. (canceled)

10. A compression method for a backup data buffer comprising a plurality of backup entries for storing persistent data of a non-volatile memory device during at least one update operation involving the persistent data, an address of the persistent data to be updated being stored in at least one address entry of a first address page included in a driver buffer comprising a plurality of address pages, the compression method comprising:
a) marking as erasable an address entry included in the first address page when the update operation on the persistent data stored in the address entry is completed;
b) copying from the first address page to a second address page of the driver buffer address entries not marked as erasable in step a) so as to compress the address entries not marked in the second address page; and
c) erasing the first address page to render the first address page ready to store persistent data involved in another update operation.

11. A compression method according to claim 10 further comprising copying the second address page of the driver buffer into the first address page or into an address page ready to be written.

12. A compression method according to claim 10 wherein all the entries stored inside the second address page are not marked as erasable.

13. A compression method according to claim 10 wherein the first and second address pages have a size that is a multiple of a size of a memory portion of the persistent data to be restored in the non-volatile memory.

14. A compression method according to claim 13 wherein the multiple is equal to the size of the memory portion.

15. A compression method according to claim 10 wherein the address entries further comprise a length entry for storing a length of the persistent data to be stored in the backup entries.

16. A compression method according to claim 15 wherein the address entries further comprise an index entry for linking the address and length entries to the backup entries.

17. A compression method according to claim 15 wherein a plurality of the index entries are grouped into an index page.

18. A compression method according to claim 15 wherein a plurality of length entries are grouped into a length page.

19. A compression method according to claim 18 wherein a plurality of index entries and the plurality of length entries are aligned to a plurality of address entries.

20. A method for operating a non-volatile memory comprising:
storing persistent data in a plurality of memory portions; and
storing persistent data during at least one update operation in a backup data buffer comprising a plurality of backup entries, an address of the persistent data to be updated being stored in at least one address entry of a first address page included in a driver buffer, and compressing the persistent data being stored by
a) marking as erasable an address entry included in the first address page when the update operation on the persistent data stored in the address entry is completed,
b) copying from the first address page to a second address page of said driver buffer address entries not marked as erasable in step a) so as to compress the address entries not marked in the second address page, and
c) erasing the first address page to render the first address page ready to store persistent data involved in another update operation.

21. A method according to claim 20 further comprising copying the second address page of the driver buffer into the first address page or into an address page ready to be written.

22. A method according to claim 20 wherein all the entries stored inside the second address page are not marked as erasable.

23. A method according to claim 20 wherein the first and second address pages have a size that is a multiple of a size of a memory portion of the persistent data to be restored in the non-volatile memory.

24. A method according to claim 23 wherein the multiple is equal to the size of the memory portion.

25. A method according to claim 20 wherein the address entries further comprise a length entry for storing a length of the persistent data to be stored in the backup entries.

26. A method according to claim 25 wherein the address entries further comprise an index entry for linking the address and length entries to the backup entries.

27. A method according to claim 25 wherein a plurality of the index entries are grouped into an index page.

28. A method according to claim 25 wherein a plurality of length entries are grouped into a length page.

29. A method according to claim 28 wherein a plurality of index entries and the plurality of length entries are aligned to a plurality of address entries.

30. A non-volatile memory comprising:
a plurality of memory portions for storing persistent data;
a driver buffer comprising a plurality of address pages; and
a backup data buffer comprising a plurality of backup entries for storing persistent data during at least one update operation involving persistent data, an address of the persistent data to be updated being stored in at least one address entry of a first address page included in said driver buffer, said backup data buffer cooperating with said plurality of memory portions and said driver buffer for
a) marking as erasable an address entry included in the first address page when the update operation on the persistent data stored in the address entry is completed,
b) copying from the first address page to a second address page of said driver buffer address entries not marked as erasable in step a) so as to compress the address entries not marked in the second address page, and
d) erasing the first address page to render the first address page ready to store persistent data involved in another update operation.

31. A non-volatile memory according to claim 30 further comprising copying the second address page of the driver buffer into the first address page or into an address page ready to be written.

32. A non-volatile memory according to claim 30 wherein all the entries stored inside the second address page are not marked as erasable.

33. A non-volatile memory according to claim 30 wherein the first and second address pages have a size that is a multiple of a size of a memory portion of the persistent data to be restored in the non-volatile memory.

34. A non-volatile memory according to claim 33 wherein the multiple is equal to the size of the memory portion.

35. A non-volatile memory according to claim 30 wherein the address entries further comprise a length entry for storing a length of the persistent data to be stored in the backup entries.

36. A non-volatile memory according to claim 35 wherein the address entries further comprise an index entry for linking the address and length entries to the backup entries.

37. A non-volatile memory according to claim 35 wherein a plurality of the index entries are grouped into an index page.

38. A non-volatile memory according to claim 37 wherein a plurality of length entries are grouped into a length page.

39. A non-volatile memory according to claim 38 wherein a plurality of index entries and the plurality of length entries are aligned to a plurality of address entries.
